(19) United States
(12) Patent Application Publication
(10) Pub. No.: US 2016/0019394 A1
(43) Pub. Date: Jan. 21, 2016

(54) METHOD AND SYSTEM FOR PRIVACY PRESERVING COUNTING

(71) Applicant: THOMSON LICENSING, Issy Ies Moulineaux (FR)

(72) Inventors: Efstratios IOANNIDIS, Boston, MA (US); Ehud WEINSBERG, Menlo Park, CA (US); Nina Anne TAFT, San Francisco, CA (US); Marc JOYE, Palo Alto, CA (US); Valeria NIKOLAENKO, Stanford, CA (US)

(21) Appl. No.: 14/771,608

(22) PCT Filed: Dec. 19, 2013
(86) PCT No.: PCT/US2013/076353

§ 371 Date: Aug. 31, 2015

Related U.S. Application Data
(60) Provisional application No. 61/864,098, filed on Aug. 9, 2013.
(60) Provisional application No. 61/864,094, filed on Aug. 9, 2013.
(60) Provisional application No. 61/864,088, filed on Aug. 9, 2013.
(60) Provisional application No. 61/864,085, filed on Aug. 9, 2013.
(60) Provisional application No. 61/772,404, filed on Mar. 4, 2013.

(51) Int. Cl. G06F 21/60; G06F 21/64

(52) U.S. Cl. CPC G06F 21/602; G06F 21/64

(57) ABSTRACT

A method includes: receiving a set of records from a source, wherein each record in the set of records includes a set of tokens, and wherein each record is kept secret from parties other than the source, and evaluating the set of records with a garbled circuit, wherein the output of the garbled circuit is a count based on the set of tokens. An apparatus includes: a processor, that communicates with at least one input/output interface and at least one memory in signal communication with the processor, and wherein the processor is configured to: receive a set of records from a source, wherein each record includes a set of tokens, and wherein each record is kept secret from parties other than the source and evaluate the set of records with a garbled circuit, wherein the output of the garbled circuit is a count based on the set of tokens.

### CROSS-REFERENCE TO RELATED APPLICATIONS

This application claims priority under 35 U.S.C. 119(e) to the U.S. Provisional Patent Applications filed on Aug. 9, 2013: Ser. No. 61/864085 and titled “A METHOD AND SYSTEM FOR PRIVACY PRESERVING COUNTING”; Ser. No. 61/864088 and titled “A METHOD AND SYSTEM FOR PRIVACY PRESERVING MATRIX FACTORIZATION”; Ser. No. 61/864094 and titled “A METHOD AND SYSTEM FOR PRIVACY-PRESERVING RECOMMENDATION TO RATING CONTRIBUTING USERS BASED ON MATRIX FACTORIZATION”; and Ser. No. 61/864098 and titled “A METHOD AND SYSTEM FOR PRIVACY-PRESERVING RECOMMENDATION BASED ON MATRIX FACTORIZATION AND RIDGE REGRESSION”. The provisional applications are expressly incorporated by reference herein in their entirety for all purposes.

### TECHNICAL FIELD

The present principles relate to privacy-preserving recommendation systems and secure multi-party computation, and in particular, to counting securely in a privacy-preserving fashion.

### BACKGROUND

A great deal of research and commercial activity in the last decade has led to the wide-spread use of recommendation systems. Such systems offer users personalized recommendations for many kinds of items, such as movies, TV shows, music, books, hotels, restaurants, and more. FIG. 1 illustrates the components of a general recommendation system 100: a number of users 110 representing a Source and a Recommender System (RecSys) 130 which processes the user's inputs 120 and outputs recommendations 140. To receive useful recommendations, users supply substantial personal information about their preferences (user's inputs), trusting that the recommender will manage this data appropriately.

Nevertheless, earlier studies, such as those by B. Mobasher, R. Burke, R. Bhaumik, and C. Williams: “Toward trustworthy recommender systems: An analysis of attack models and algorithm robustness.”, ACM Trans. Internet Techn., 7(4), 2007, and by E. A\ddot{}1imeur, G. Brassard, J. M. Fernandez, and F. S. M. Onana: “ALAMBIC: A privacy-preserving recommender system for electronic commerce”, Int. Journal Inf. Sec., 7(5), 2008, have identified multiple ways in which recommenders can abuse such information or expose the user to privacy threats. Recommenders are often motivated to resell data for a profit, but also to extract information beyond what is intentionally revealed by the user. For example, even records of user preferences typically not perceived as sensitive, such as movie ratings or a person's TV viewing history, can be used to infer a user's political affiliation, gender, etc. The private information that can be inferred from the data in a recommendation system is constantly evolving as new data mining and inference methods are developed, for either malicious or benign purposes. In the extreme, records of user preferences can be used to even uniquely identify a user: A. Naranyan and V. Shmatikov strikingly demonstrated this by de-anonymizing the Netflix dataset in “Robust de-anonymization of large sparse datasets”, in IEEE S&P, 2008. As such, even if the recommender is not malicious, an unintentional leakage of such data makes users susceptible to linkage attacks, that is, an attack which uses one database as auxiliary information to compromise privacy in a different database.

Because one cannot always foresee future inference threats, accidental information leakage, or insider threats (purposeful leakage), it is of interest to build a recommendation system in which users do not reveal their personal data in the clear. There are no practical recommendation systems today that operate on encrypted data. In addition, it is of interest to build a recommender which can profile items without ever learning the ratings that users provide, or even which items the users have rated. This invention addresses one aspect of such a secure recommendation system, which can also be utilized for purposes other than recommendation.

### SUMMARY

The present principles propose a method and system for counting securely, in a privacy-preserving fashion. In particular, the method receives as input a set of records (the “corpus”), each comprising of its own set of tokens. In addition, the method receives as input a separate set of tokens, and is to find in how many records each token appears. The method counts in how many records each token appears without ever learning the contents of any individual record or any information extracted from the records other than the counts.

According to one aspect of the present principles, a method for securely counting records is provided such that the records are kept private from an Evaluator (230) which will evaluate the records, the method including: receiving a set of records (220, 340), wherein each record comprises a set of tokens, and wherein each record is kept secret from parties other than the source of the record; and evaluating the set of records with a garbled circuit (370), wherein the output of the garbled circuit are counts. The method can include: receiving or determining a separate set of tokens (320). The method can further include: designing the garbled circuit in a Crypto-System Provider (CSP) to count the separate set of tokens in the set of records (350); and transferring the garbled circuit to the Evaluator (360). The step of designing in this method can include: designing a counter as a Boolean circuit (352). The step of designing a counter in this method can include: constructing an array of the set of records and the separate set of tokens (410); and performing the operations of sorting (420, 440), shifting (430), adding (430) and storing on the array. The step of receiving in this method can be performed through proxy oblivious transfers (342) between a Source, the Evaluator and the CSP (350), wherein the Source provides the records and the records are kept private from the Evaluator and the CSP, and wherein the garbled circuit takes as inputs the garbled values of the records. The method can further include: receiving a set of parameters for the design of a garbled circuit by the CSP, wherein the parameters were sent by the Evaluator (330).

According to one aspect of the present principles, the method can further include: encrypting the set of records to create encrypted records (380), wherein the step of encrypting is performed prior to the step of receiving a set of records. The step of designing (350) in this method can include: decrypting the encrypted records inside the garbled circuit (354). The encryption system can be a partially homomorphic encryption (382) and the method can further include: masking the encrypted records in the Evaluator to create masked records (385); and decrypting the masked records in the CSP to create decrypted-masked records (395). The step of designing (350) in this method can include: unmasking the decrypted-masked records inside the garbled circuit prior to processing them (356).

According to one aspect of the present principles, each record in this method can further include a set of weights, wherein the set of weights comprises at least one weight. The weight in this method can correspond to one of a measure of frequency and rating of the respective token in the record.

According to one aspect of the present principles, the method can further include: receiving the number of tokens of each record (220, 310). Furthermore, the method can further include: padding each record with null entries when the number of tokens of each record is smaller than a value representing a maximum value, in order to create records with a number of tokens equal to this value (312). The Source of the set of records in this method can be one of a set of users (210) and a database and, if the Source is a set of users, each user provides a at least one record.

According to one aspect of the present principles, a system for securely counting records is proposed including a Source which will provide the records, a Crypto-Service Provider (CSP) which will provide the secure counter and an Evaluator which will evaluate the records, such that the records are kept private from the Evaluator and from the CSP, wherein the Source, the CSP and the Evaluator each includes: a processor (402), for receiving at least one input/output (404); and at least one memory (406, 408) in signal communication with the processor, wherein the Evaluator processor is configured to: receive a set of records, wherein each record includes a set of tokens, and wherein each record is kept secret; and evaluate the set of records with a garbled circuit, wherein the output of the garbled circuit are counts. The Evaluator processor in the system can be configured to: receive a separate set of tokens. The CSP processor in the system can be configured to: design the garbled circuit in a CSP to count the separate set of tokens in the set of records; and transfer the garbled circuit to the Evaluator. The CSP processor in the system can be configured to design the garbled circuit by being configured to: design a counter as a Boolean circuit. The CSP processor in the system can be configured to design the counter by being configured to: construct an array of the set of records and the separate set of tokens; and perform the operations of sorting, shifting, adding and storing on the array. The Source processor, the Evaluator processor and the CSP processor can be configured to perform proxy oblivious transfers, wherein the Source provides the records, the Evaluator receives the garbled values of the records and the records are kept private from the Evaluator and the CSP, and wherein the garbled circuit takes as inputs the garbled values of the records. The CSP processor in this system can be further configured to: receive a set of parameters for the design of a garbled circuit, wherein the parameters were sent by the Evaluator.

According to one aspect of the present principles, the Source processor in the system can be configured to: encrypt the set of records to create encrypted records prior to providing the set of records. The CSP processor in the system can be configured to design the garbled circuit by being further configured to: decrypt the encrypted records inside the garbled circuit prior to processing them. The encryption can be a partially homomorphic encryption and the Evaluator processor in the system can be further configured to: mask the encrypted records to create masked records; and the CSP processor can be further configured to: decrypt the masked records to create decrypted-masked records. The CSP processor can be configured to design the garbled circuit by being further configured to unmask the decrypted-masked records inside the garbled circuit prior to processing them.

According to one aspect of the present principles, each record in this system can further include a set of weights, wherein the set of weights comprises at least one weight. The weight in this system can correspond to one of a measure of frequency and rating of the respective token in the record.

According to one aspect of the present principles, the Evaluator processor in this system can be further configured to: receive the number of tokens of each record, wherein the number of tokens were sent by the Source. The Source processor in this system can be configured to: pad each record with null entries when the number of tokens of each record is smaller than a value representing a maximum value, in order to create records with a number of tokens equal to this value. The Source of the set of records in this system can be one of a database and a set of users, and wherein if the Source is a set of users, each user comprises a processor (402), for receiving at least one input/output (404); and at least one memory (406, 408) and each user provides at least one record.

Additional features and advantages of the invention will be made apparent from the following detailed description of illustrative embodiments which proceeds with reference to the accompanying figures.

### BRIEF DESCRIPTION OF THE DRAWINGS

The present principles may be better understood in accordance with the following exemplary figures briefly described below

FIG. 1 illustrates the components of a prior art recommendation system;

FIG. 2 illustrates the components of a privacy-preserving counting system according to the present principles;

FIG. 3 illustrates a flowchart of a privacy-preserving counting method according to the present principles;

FIG. 4 illustrates a flowchart of a counter according to the present principles; and

FIG. 5 illustrates a block diagram of a computing environment utilized to implement the present principles.

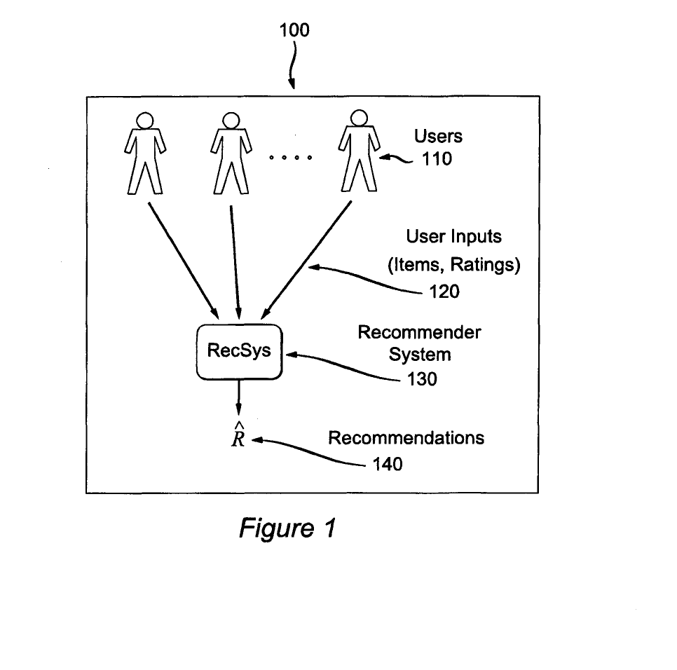

### DETAILED DISCUSSION OF THE EMBODIMENTS

In accordance with the present principles, a method is provided for counting securely, in a privacy-preserving fashion. One skilled in the art will appreciate that there are many applications for this invention. One possible application is counting how often keywords from a given set appear in the emails of an individual or multiple individuals. An online service may wish to find the frequency of occurrence of, e.g., the word “cinema”, “tickets”, “shoes”, etc. in the corpus of emails, in order to decide what ads to show to the user(s). This method allows the service to perform such counts, without ever learning explicitly the contents of each email.

The formal description of the problem solved by the present principles is: a service wishes to count the number of occurrences of tokens in a corpus of records, each comprising a set of tokens. A skilled artisan will recognize in the example above that the records could be emails, the tokens could be words, and the service wishes to count the number of records using a certain keyword. However, to ensure the privacy of the individuals involved, the service wishes to do so without learning anything other than these counts. In particular, the service should not learn: (a) in which records/emails each keyword appeared or, a fortiori, (b) what tokens/words appear in each email.

Another application is computing the number of views, or even average rating to an item, e.g., a movie, from a corpus of ratings, without revealing who rated each movie or what rating they gave. In this case, a record is the set of movies rated/viewed by a user, as well as the respective ratings and a token is a movie id. The present invention can be used to count how many users rated or viewed a movie, without ever learning which user viewed which movie. Moreover, this invention can be used to compute statistics such as the average rating per movie, without ever learning which user rated which movie, or what rating the user gave. Similarly, this invention can also be used for voting computations in elections of a single candidate (e.g., mayor, or the winner of a competition) or multiple candidates (e.g., a board of representatives), without ever learning the votes of each user.

Therefore, according to the present principles, a method receives as input a set of records (the “corpus”), each comprising of its own set of tokens. The set or records includes at least one record and the set of tokens includes at least one token. In addition, the method receives as input a separate set of tokens, and is to find in how many records each token in the separate set of tokens appears. The separate set of tokens may include all the tokens in all the records, a subset of the tokens in all the records, or may even contain tokens not present in the records. The method counts in how many records each token appears in a secure way, without ever learning the contents of any individual record or any information extracted from the records other than the counts. This method is implemented by a secure multi-party computation (MPC) algorithm, as discussed below.

Secure multi-party computation (MPC) was initially proposed by A. Chi-Chih Yao in the 1980's. Yao's protocol (a.k.a. garbled circuits) is a generic method for secure multi-party computation. In a variant thereof, adapted from “Privacy-preserving Ridge Regression on Hundreds of millions of records”, in IEEE S&P, 2013, by V. Nikolaenko, U. Weinsberg, S. Ioannidis, M. Joye, D. Boneh, and N. Taft, the protocol is run between a set of n input owners, where aᵢ denotes the private input of user i, 1<i<n, an Evaluator, that wishes to evaluate ƒ(a₁, . . . , aₙ), and a third party, the Crypto-Service Provider (CSP). At the end of the protocol, the Evaluator learns the value of ƒ(a₁, . . . , aₙ) but no party learns more than what is revealed from this output value. The protocol requires that the function ƒ can be expressed as a Boolean circuit, e.g. as a graph of OR, AND, NOT and XOR gates, and that the Evaluator and the CSP do not collude.

There are recently many frameworks that implement Yao's garbled circuits. A different approach to general purpose MPC is based on secret-sharing schemes and another is based on fully-homomorphic encryption (FHE). Secret-sharing schemes have been proposed for a variety of linear algebra operations, such as solving a linear system, linear regression, and auctions. Secret-sharing requires at least three non-colluding online authorities that equally share the workload of the computation, and communicate over multiple rounds; the computation is secure as long as no two of them collude. Garbled circuits assumes only two noncolluding authorities and far less communication which is better suited to the scenario where the Evaluator is a cloud service and the Crypto-Service Provider (CSP) is implemented in a trusted hardware component.

Regardless of the cryptographic primitive used, the main challenge in building an efficient algorithm for secure multi-party computation is in implementing the algorithm in a data-oblivious fashion, i.e., so that the execution path does not depend on the input. In general, any RAM program executable in bounded time T can be converted to a O(T̂3) Turing machine (TM), which is a theoretical computing machine invented by Alan Turing to serve as an idealized model for mathematical calculation and wherein O(T̂3) means that the complexity is proportional to T³. In addition, any bounded T-time TM can be converted to a circuit of size O(T log T), which is data-oblivious. This implies that any bounded T-time executable RAM program can be converted to a data-oblivious circuit with a O(T̂3 log T) complexity. Such complexity is too high and is prohibitive in most applications. A survey of algorithms for which efficient data-oblivious implementations are unknown can be found in “Secure multi-party computation problems and their applications: A review and open problems”, in New Security Paradigms Workshop, 2001, by W. Du and M. J. Atallah.

Sorting networks were originally developed to enable sorting parallelization as well as an efficient hardware implementation. These networks are circuits that sort an input sequence (a₁, a₂, . . . , aₙ) into a monotonically increasing sequence (a′₁, a′₂, . . . , a′ₙ). They are constructed by wiring together compare-and-swap circuits, their main building block. Several works exploit the data-obliviousness of sorting networks for cryptographic purposes. However, encryption is not always enough to ensure privacy. If an adversary can observe your access patterns to encrypted storage, they can still learn sensitive information about what your applications are doing.

The present principles propose a method based on secure multi-party sorting which is close to weighted set intersection but which incorporates garbled circuits and concentrates on counting. A naïve way of implementing the counter of the present principles using garbled circuits has a very high computational cost, requiring computations quadratic to the number of tokens in the corpus. The implementation proposed in the present principles is much faster, at a cost almost linear to the number of tokens in the corpus.

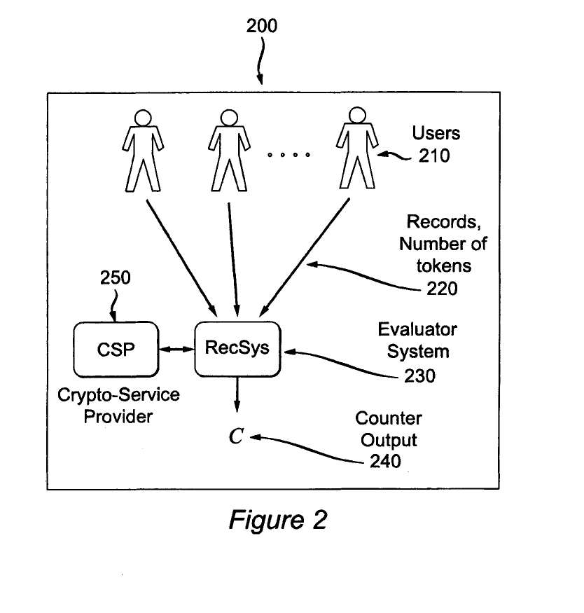

The present principles consist of three components, as illustrated in FIG. 2:
I. The Evaluator System (Eval) 230, an entity that performs the secure counting without learning anything about the records or any information extracted from the records other than the counts C 240.
II. A Crypto-Service-Provider (CSP) 250 that will enable the secure computation without learning anything about the records or any information extracted from the records.
III. A Source, consisting of one or more users 210, each having a record or a set of records 220, each record comprising a set of tokens that are to be counted, and each record being kept secret from parties other than the source of the record (that is, the user). Equivalently, the Source may represent a database containing the data of one or more users.

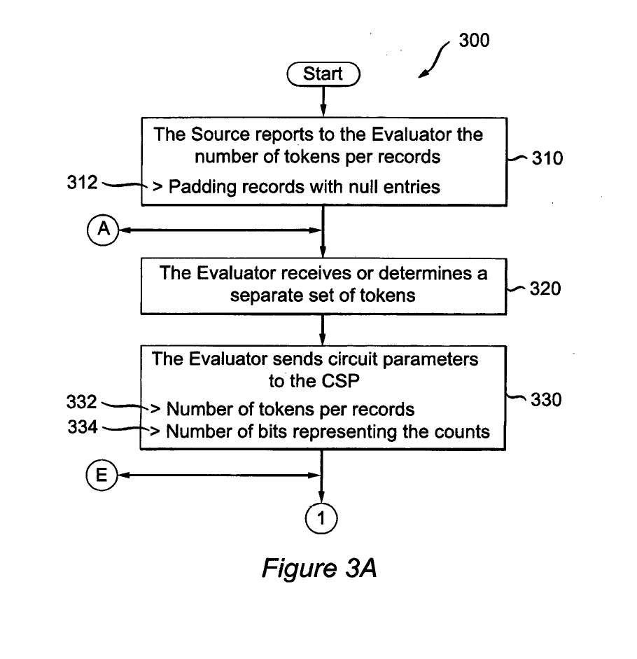

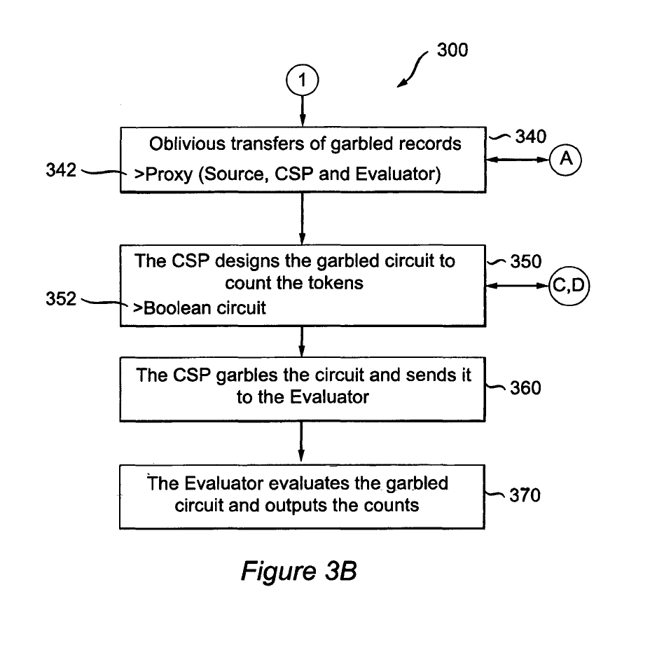

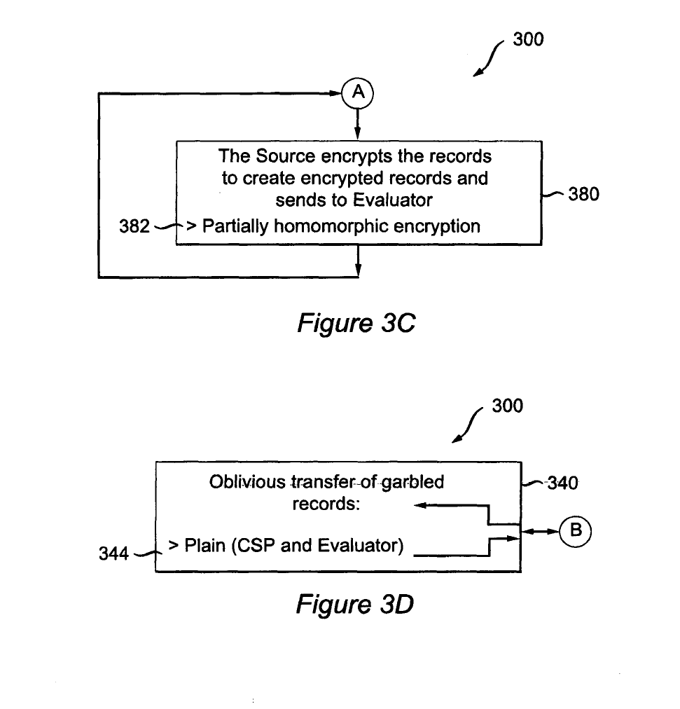

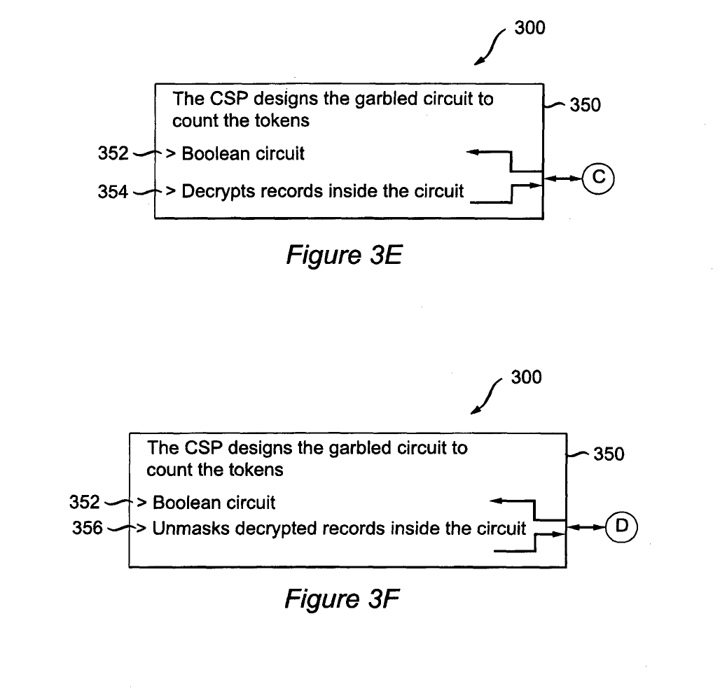

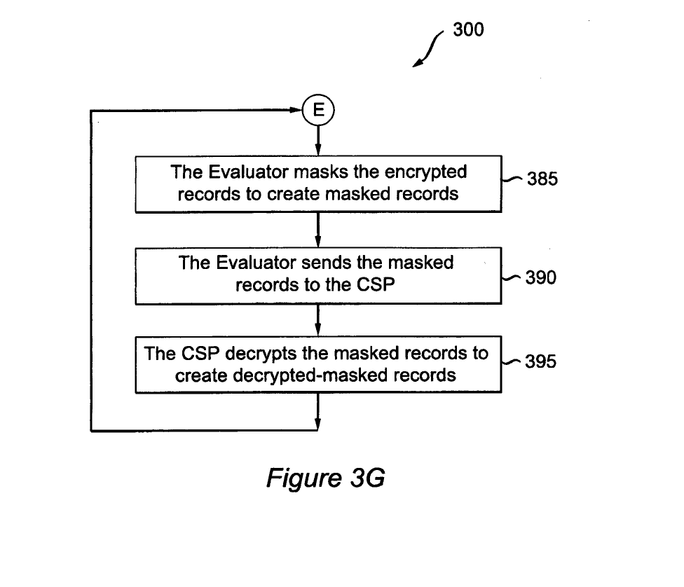

The preferred embodiment of the present principles comprises a protocol satisfying the flowchart 300 in FIG. 3 and described by the following steps:
P1. The Source reports to the Evaluator how many tokens are going to be submitted for each participating record 310;
P2. The Evaluator reports to the CSP the necessary parameters to design a garbled circuit 330, which include the numbers of tokens 332 and the number of bits used to represent the counts 334. In addition, the Evaluator receives or determines a separate set of tokens 320, on which to compute the counts. This set of tokens may comprise all the tokens in the corpus, a subset of all the tokens, or even tokens not present in the records. The separate set of tokens, if not all the tokens, will be included in the parameters.
P3. The CSP prepares what is known to the skilled artisan as a garbled circuit that computes the counts 350. In order to be garbled, a circuit is first written as a Boolean circuit. 352. The input to the circuit is assumed to be a list of tokens (token_id_{—}1, token_id_{—}2, . . . , token_id_M) where M is the total number of tokens in the corpus (i.e., the sum of tokens submitted by each user). Specifically, the garbled circuit takes as inputs the garbled values of the records/tokens and processes the set of records and the separate set of tokens T1 to count in how many records each token belonging to the separate set of tokens appears without learning the contents of any individual record and of any information extracted from the records other than the counts.
P4. The CSP garbles this circuit, and sends it to the Evaluator 360. Specifically, the CSP processes gates into garbled tables and transmits them to the Evaluator in the order defined by circuit structure.
P5. Through proxy oblivious transfers between the Source, the Evaluator, and the CSP 342, the Evaluator learns the garbled values of the inputs of the users, without either itself or the CSP learning the actual values. A skilled artisan will understand that an oblivious transfer is a type of transfer in which a sender transfers one of potentially many pieces of information to a receiver, which remains oblivious as to what piece (if any) has been transferred. A proxy oblivious transfer is an oblivious transfer in which 3 or more parties are involved. In particular, in this proxy oblivious transfer, the Source provides the records/tokens, the Evaluator receives garbled values of the records/tokens and the CSP acts as the proxy, while neither the Evaluator nor the CSP learn the records.
P6. The Evaluator evaluates the garbled circuit and outputs the requested values 370.

Technically, this protocol leaks beyond C 240 also the number of tokens provided by each user. This can be rectified through a simple protocol modification, e.g., by “padding” records submitted with appropriately “null” entries until reaching pre-set maximum number 312. For simplicity, the protocol was described without this “padding” operation.

The circuit implementation proposed by this invention uses a sorting network. In short, the circuit places all inputs in an array, along with counters for each token. It then sorts the array ensuring that counters are permuted in a way so that they are immediately adjacent to tokens that must be counted. By performing a linear pass through the array, the circuit can then count how many times a token appears, and store this information in the appropriate counter.

In an exemplary detailed description of the counting circuit of the present principles, it is assumed the standard “collaborative filtering” setting, wherein n users rate a subset of m possible items (e.g., movies). For [n] := {1, . . . , n} the set of users, and [m] := {1, . . . , m} the set of items, denote by [symbol] ⊂[n]×[m] the user/item pairs for which a rating has been generated, and by M=[ [symbol] ] the total number of ratings. Finally, for (i, j)∈ [symbol] , denote by r_{i,j}∈ [symbol] the rating generated by user i for item j.

In a practical setting, both n and m are large numbers, typically ranging between 10⁴ and 10⁶. In addition, the ratings provided are sparse, that is, M=O(n+m), which is much smaller than the total number of potential ratings n×m. This is consistent with typical user behavior, as each user may rate only a finite number of items (not depending on m, the “catalogue” size).

The present principles also assume that cⱼ=|{i:(i,j)∈ [symbol] }| is the number of ratings item j∈[m] received, and that the circuit takes as input the set [symbol] and outputs the counts {cⱼ}_{j∈[m]}. A skilled artisan will understand that the complexity of such task in the RAM model is O(m+M), as all cⱼ can be computed simultaneously by a single pass over [symbol] , at the expense of a high degree of parallelism. In contrast, a naïve circuit implementation using indicators δ_{i,j}=1_{(i,j)∈} [symbol] , which is 1 if i rated j and 0 otherwise, yields a circuit complexity of O(n×m), which is extremely high.

The inefficiency of the naïve implementation arises from the inability to identify which users rate an item and which items are rated by a user at the time of the circuit design, mitigating the ability to leverage the inherent sparsity in the data. Instead, the present principles propose a circuit that performs such a matching between users and items efficiently within a circuit, and can return {cⱼ}_{j∈[m]}in O((m+M)polylog(m+M)) steps using a sorting network, where polylog implies a polylogarithmic function.

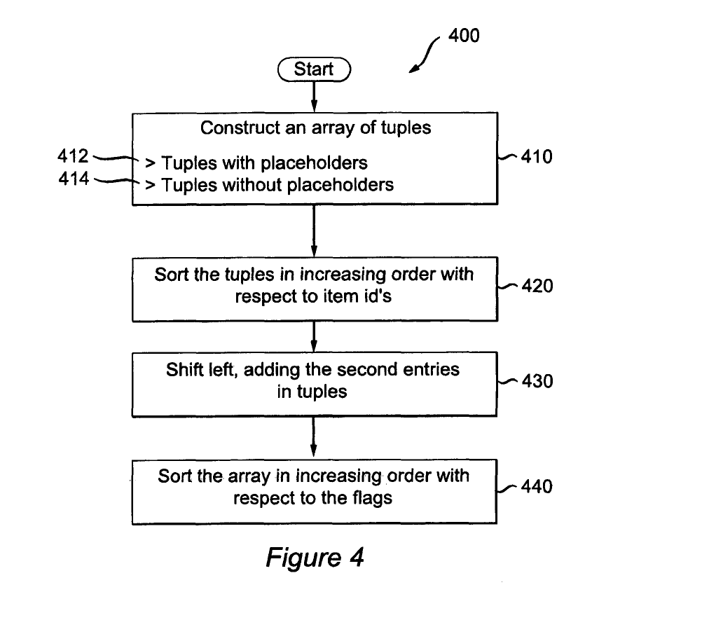

The counter according to a preferred embodiment of the present principles satisfying the flowchart 400 in FIG. 4 can be described by the following steps:
C1. Given [symbol] as input, construct an array S of (m+M) tuples 410. First, for each j∈[m], create a tuple of the form (j, ⊥, 0), where the “null” symbol ⊥ is a placeholder 412. Second, for each (i, j)∈ [symbol] , create a tuple of the form(j, 1,1) 414, yielding:

$$S = ( \begin{matrix}1 & 2 & & m & {j}_{1} & {j}_{2} & & {j}_{M} \\ ⊥ & ⊥ & … & ⊥ & 1 & 1 & … & 1 \\ 0 & 0 & & 0 & 1 & 1 & & 1\end{matrix} ) \qquad ( 1 )$$

Intuitively, the first m tuples will serve as “counters”, storing the number of counts per token. The remaining M tuples contain the “input” to be counted. The third element in each tuple serves as a binary flag, separating counters from input.
C2. Sort the tuples in increasing order with respect to the item ids 420, i.e., the 1st element in each tuple. If two ids are equal, break ties by comparing tuple flags, i.e., the 3rd elements in each tuple. Hence, after sorting, each “counter” tuple is succeeded by “input” tuples with the same id:

$$S = ( \begin{matrix}1 & 1 & & 1 & & m & m & & m \\ ⊥ & 1 & … & 1 & … & ⊥ & 1 & … & 1 \\ 0 & 1 & & 1 & & 0 & 1 & & 1\end{matrix} ) \qquad ( 2 )$$

C3. Starting from the right-most tuple, move from right to left, adding the values of the second entries in each tuple 430; if a counter tuple (i.e., a zero flag) is reached, store the computed value at the ⊥ entry, and restart the counting. More formally, denote by s_{l,k} the l-th element of the k-th tuple. This “right-to-left” pass amounts to the following assignments:

s_{2,k}←s_{3,k}+s_{3,k+1}×s_{2,k+1} (3)
for k ranging from (m+M−1) down to 1.
C4. Sort the array again in increasing order, this time with respect to the flags s_{l,k} 440. The first m tuples of the resulting array contain the counters, which are released as output.

One with skill in the art will recognize that the above counter can be readily implemented as a circuit that takes as input [symbol] and outputs (j, cⱼ) for every item j∈[m]. Step 1 can be implemented as a circuit for which the inputs are the tuples (i,j)∈ [symbol] and the output is the initial array S, using O(m+M) gates. The sorting operations can be performed using, e.g., Batcher's sorting network, which takes as input the initial array and outputs the sorted array, requiring O((m+M)log′(m+M)) gates. Finally, the right-to-left pass can be implemented as a circuit that performs (3) on each tuple, also with O(m+M) gates. Crucially, the pass is data-oblivious: (3) discriminates “counter” from “input” tuples through flags s_{3,k} and s_{3,k+1} but the same operation is performed on all elements of the array. In particular, this circuit can be implemented as a Boolean circuit (e.g., as a graph of OR, AND, NOT and XOR gates, which allows the implementation to be garbled, as previously explained. For example, the garbled circuit construction may be based on FastGC, a Java-based open-source framework, which enables circuit definition using elementary xor, or and and gates. Once the circuits are constructed, the framework handles garbling, oblivious transfer and the complete evaluation of the garbled circuit.

According to the present principles, the implementation of the counter above together with the protocol previously described provides a novel method for counting securely, in a privacy-preserving fashion. In addition, this solution yields a circuit with a complexity within a polylogarithmic factor of a counter performed in the clear by the use of sorting networks.

In a second embodiment of this invention also depicted in the flowchart 300 of FIG. 3 (including additions A, B and C in the flowchart), the users submit encrypted values of their inputs to the Evaluator 380, and the CSP prepares a circuit 350 that decrypts the inputs first 354 and then operates on the data. The garbled circuit is sent to the Evaluator 360, who through (plain, not proxy) oblivious transfer 344 obtains the garbled values of the encrypted data and then uses them to evaluate the circuit. This implementation has the advantage that users can submit their inputs and then “leave” the protocol (i.e., are not required to stay online).

In a third embodiment of this invention also depicted in the flowchart 300 of FIG. 3 (including additions A, B, D and E in the flowchart), the users submit encrypted values of their inputs 380 through partially homomorphic encryption 382. A skilled artisan will appreciate that homomorphic encryption is a form of encryption which allows specific types of computations to be carried out on ciphertext and obtain an encrypted result which decrypted matches the result of operations performed on the plaintext. For instance, one person could add two encrypted numbers and then another person could decrypt the result, without either of them being able to find the value of the individual numbers. A partially homomorphic encryption is homomorphic with respect to one operation (addition or multiplication) on plaintexts. A partially homomorphic encryption may be homomorphic with respect to addition and multiplication to a scalar.

After receiving the encrypted values, the Evaluator ads a mask to the user inputs 385. One skilled in the art will understand that a mask is a form of data obfuscation, and could be as simple as a random number generator or shuffling. The Evaluator subsequently sends the masked user inputs to the CSP 390, which decrypts them 395. The CSP then prepares a garbled circuit 350 that receives the mask from the Evaluator and unmasks the inputs 356, before performing the counts, garbles it, and sends it to the Evaluator 360. Through (plain, not proxy) oblivious transfer 344 the Evaluator obtains the garbled values of the masked data and then uses them to evaluate the circuit. This implementation has the advantage that users can submit their inputs and then “leave” the protocol (i.e., are not required to stay online), and does not require decryption within the CSP.

In a fourth embodiment of this invention also satisfying the flowchart 300 of FIG. 3, the users submit inputs of the form (token_id, weight), where the weight could correspond, e.g., to the frequency with which a keyword appears in the corpus, its importance to the user. In the case where the records are movies viewed and/or rating, the weight corresponds to a rating. Then, the average rating per movie can be computed by our method by appropriately modifying the circuit. Along with counting how many ratings correspond to a movie, the “right-to-left” pass (step C3) would also sum all the ratings. The ratio of rating sums and counts would yield the average rating; other statistics (such as variance) can also be computed through similar modifications.

It is to be understood that the present principles may be implemented in various forms of hardware, software, firmware, special purpose processors, or a combination thereof. Preferably, the present principles are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

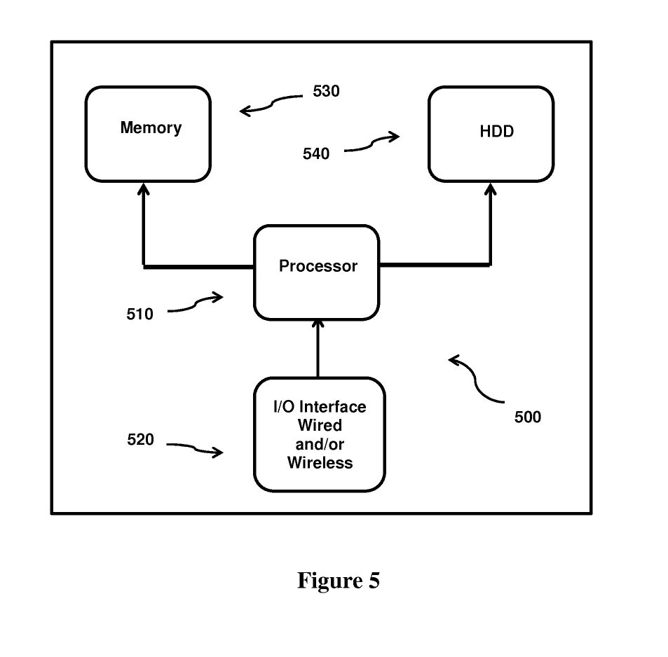

FIG. 5 shows a block diagram of a minimum computing environment 500 used to implement the present principles. The computing environment 500 includes a processor 510, and at least one (and preferably more than one) I/O interface 520. The I/O interface can be wired or wireless and, in the wireless implementation is pre-configured with the appropriate wireless communication protocols to allow the computing environment 500 to operate on a global network (e.g., internet) and communicate with other computers or servers (e.g., cloud based computing or storage servers) so as to enable the present principles to be provided, for example, as a Software as a Service (SAAS) feature remotely provided to end users. One or more memories 530 and/or storage devices (HDD) 540 are also provided within the computing environment 500. The computing environment 500 or a plurality of computer environments 500 may implement the protocol P1-6 (FIG. 3), for the counter C1-C4 (FIG. 4) according to one embodiment of the present principles. In particular, in an embodiment of the present principles, a computing environment 500 may implement the Evaluator 230; a separate computing environment 500 may implement the CSP 250 and a Source may contain one or a plurality of computer environments 500, each associated with a distinct user 210, including but not limited to desktop computers, cellular phones, smart phones, phone watches, tablet computers, personal digital assistant (PDA), netbooks and laptop computers, used to communicate with the Evaluator 230 and the CSP 250. In addition, the CSP 250 can be included in the Source as a separate processor, or as a computer program run by the Source processor, or equivalently, included in the computer environment of each User 210 of the Source.

It is to be further understood that, because some of the constituent system components and method steps depicted in the accompanying figures are preferably implemented in software, the actual connections between the system components (or the process steps) may differ depending upon the manner in which the present principles are programmed. Given the teachings herein, one of ordinary skill in the related art will be able to contemplate these and similar implementations or configurations of the present principles.

Although the illustrative embodiments have been described herein with reference to the accompanying figures, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
receiving a set of records from a source, wherein each record in the set of records comprises a set of tokens, and wherein each record is kept secret from parties other than said source; and
evaluating said set of records with a garbled circuit, wherein the output of the garbled circuit is a count based on the set of tokens.

2. The method according to claim 1, further comprising:
receiving a separate token.

3. The method according to claim 2, further comprising:
receiving the garbled circuit from a crypto-service provider to count said separate token in said set of records, wherein the garbled circuit receives the garbled values of the records as inputs.

4. The method according to claim 3, wherein the garbled circuit is a counter implemented as a Boolean circuit.

5. The method according to claim 4 wherein the counter constructs an array of said set of records and said separate token and performs the operations of sorting, shifting, adding and storing on the array.

6. The method according to claim 1, wherein receiving is performed through proxy oblivious transfers (344) between the source, the evaluator and a crypto-service provider, wherein said source provides the records, the evaluator receives garbled values of the records and the records are kept private from the evaluator and the crypto-service provider.

7. The method according to claim 3, wherein the records are encrypted records.

8. The method according to claim 7, wherein the garbled circuit decrypts the encrypted records.

9. The method according to claim 7, wherein the encryption is a partially homomorphic encryption, said method comprising:
masking the encrypted records to create masked records; and
transfering the masked records to the crypto-service provider for decryption.

10. The method according to claim 9, wherein the garbled circuit unmasks decrypted masked records.

11. The method according to claim 1, wherein each record further comprises a set of weights, wherein said set of weights comprises at least one weight.

12. The method according to claim 11, wherein the at least one weight corresponds to one of a measure of frequency and rating of the respective token in the record.

13. The method according to claim 1, further comprising:
receiving a number of tokens of each record; and
sending a set of parameters including the number of tokens to the crypto-service provider for the implementation of the garbled circuit, wherein the parameters were sent by said evaluator.

14. The method according to claim 1, wherein the records are padded with null entries when the number of tokens of each record is smaller than a maximum value, in order to create records with a number of tokens equal to said maximum value.

15. The method according to claim 1, wherein the source of the set of records is one of a set of users and a database, wherein each user is a source of one record and said one record is kept secret from parties other than said each user.

16. The method according to claim 3, further comprising:
sending a set of parameters to the crypto-service provider for the implementation of the garbled circuit, wherein the parameters were sent by said evaluator.

17. An apparatus comprising:
a processor, that communicates with at least one input/output interface; and
at least one memory in signal communication with said processor, and wherein the processor is configured to:
receive a set of records from a source, wherein each record comprises a set of tokens, and wherein each record is kept secret from parties other than the source; and
evaluate said set of records with a garbled circuit, wherein the output of the garbled circuit is a count based on said set of tokens.

18. The apparatus according to claim 17, wherein the processor is configured to:
receive a separate token.

19. The apparatus according to claim 18, wherein the processor is further configured to:
receive the garbled circuit from a crypto-service provider to count said separate token in said set of records, wherein the garbled circuit takes as inputs the garbled values of the records.

20. The apparatus according to claim 19, wherein the counter is implemented as a Boolean circuit.

21. The apparatus according to claim 20 wherein the counter constructs an array of said set of records and said separate token and performs the operations of sorting, shifting, adding and storing on the array.

22. The apparatus according to claim 17, wherein the processor receives a set of records by being configured to perform proxy oblivious transfers with said source and a crypto-service provider, wherein said source provides the records, said evaluator receives the garbled values of the records and the records are kept private from the evaluator and the crypto-service provider.

23. The apparatus according to claim 19, wherein the records are encrypted records.

24. The apparatus according to claim 23, wherein the garbled circuit decrypts the encrypted records.

25. The apparatus according to claim 23, wherein the encryption is a partially homomorphic encryption, and wherein the processor is further configured to:
mask the encrypted records to create masked records; and
transfer the masked records to the crypto-service provider for decryption.

26. The apparatus according to claim 25, wherein the garbled circuit unmasks the decrypted masked records.

27. The apparatus according to claim 17, wherein each record further comprises a set of weights, wherein said set of weights comprises at least one weight.

28. The apparatus according to claim 27, wherein the at least one weight corresponds to one of a measure of frequency and rating of the respective token in the record.

29. The apparatus according to claim 17, wherein the evaluator processor is further configured to:
receive a number of tokens of each record, wherein the number of tokens were sent by said source; and
send a set of parameters including the number of tokens to the crypto-service provider for the implementation of a garbled circuit.

30. The apparatus according to claim 17, wherein the records are padded with null entries when the number of tokens of each record is smaller than a value representing a maximum value, in order to create records with a number of tokens equal to said maximum value.

31. The apparatus according to claim 17, wherein the source of the set of records is one of a database and a set of users, and wherein if the source is a set of users, each user comprises a processor, for receiving at least one input/output (504); and at least one memory.

32. The apparatus according to claim 19, wherein the processor is further configured to:
send a set of parameters to the crypto-service provider for the implementation of a garbled circuit.

33. A method comprising:
Implementing a garbled circuit to count a separate token in said set of records (350), wherein the garbled circuit takes as inputs the garbled values of the records, each record is received from a respective user, comprises a set of tokens and is kept secret from parties other than said respective user; and
transferring the garbled circuit to an evaluator (360), wherein said evaluator evaluates said garbled circuit and provides said count.

34. The method according to claim 33, wherein implementing comprises:
implementing a counter as a Boolean circuit.

35. The method according to claim 34, wherein the counter performs counting by constructing an array of said set of records and performing the operations of sorting, shifting, adding and storing on the array.

36. The method according to claim 33 further comprising:
receiving masked records from the evaluator, wherein the evaluator masked encrypted records and wherein the encryption is a partially homomorphic encryption, said method; and
decrypting said masked records.

37. The method according to claim 36, wherein implementing comprises:
unmasking the decrypted masked records inside the garbled circuit prior to processing them.

38. The method according to claim 33, further comprising:
performing oblivious transfers with the source and the evaluator, wherein said source provides the records, said evaluator receives garbled values of the records and the records are kept private from the evaluator and the crypto-service provider.

39. An apparatus comprising:
a processor that communicates with at least one input/output interface; and
at least one memory in signal communication with said processor, wherein the processor is configured to:
implement a garbled circuit to count a separate token in said set of records, wherein the garbled circuit takes as inputs the garbled values of the records, each record is received from a respective user, comprises a set of tokens and is kept secret from parties other than said respective user; and
transfer the garbled circuit to an evaluator, wherein said evaluator evaluates said garbled circuit and provides said count.

40. The apparatus according to claim 39, wherein the garbled circuit implements the counter as a Boolean circuit.

41. The apparatus according to claim 40, wherein the counter performs counting by constructing an array of said set of records and performing the operations of sorting, shifting, adding and storing on the array.

42. The apparatus according to claim 39, wherein the processor is further configured to:
receive masked records from the evaluator, wherein the evaluator masked encrypted records and wherein the encryption is a partially homomorphic encryption, said method; and
decrypt said masked records to create decrypted masked records.

43. The apparatus according to claim 42, wherein the processor is configured to implement by being further configured to:
unmask the decrypted masked records inside the garbled circuit prior to processing them.

44. The apparatus according to claim 39, wherein the processor is further configured to:
perform oblivious transfers with the source and the evaluator, wherein said source provides the records, said evaluator receives garbled values of the records and the records are kept private from the evaluator and the crypto-service provider.

45. A method comprising:
sending a record to an evaluator, wherein said record comprises a set of tokens and is kept secret from parties other than said user, wherein said evaluator evaluates a set of records including said record sent by the user and a separate token with a garbled circuit, wherein the output of the garbled circuit is a count based on the set of tokens.

46. The method of claim 45, further comprising:
encrypting the set of records to create encrypted records prior to providing said set of records.

47. An apparatus comprising:
a processor that communicates with at least one input/output interface ; and
at least one memory in signal communication with said processor, wherein the processor is configured to:
send a record to an evaluator, wherein said record comprises a set of tokens and is kept secret from parties other than said user, wherein said evaluator will evaluate said set of records and a separate token with a garbled circuit, wherein the output of the garbled circuit is a count based on the set of tokens.

48. The apparatus according to claim 47, wherein the processor is further configured to:
encrypt the set of records to create encrypted records prior to providing said set of records.
